(19) United States
(12) Patent Application Publication
(10) Pub. No.: US 2024/0139047 A1
(43) Pub. Date: May 2, 2024

(54) Body Position Adjustment System

(71) Applicant: Diana Jeanne Kuzlik, Orland Park, IL (US)

(72) Inventor: Diana Jeanne Kuzlik, Orland Park, IL (US)

(21) Appl. No.: 18/051,455

(22) Filed: Oct. 31, 2022

(51) Int. Cl. A61G 7/005; A61G 7/008; A61G 7/05

(52) U.S. Cl. CPC A61G 7/005; A61G 7/008; A61G 7/0504; A61G 7/0507

(57) ABSTRACT

A body position adjustment system is a system that helps bedridden users avoid medical ailments resulting from laying on a bed for long periods of time. The system includes a repositioning belt, a translation mechanism, and an anchoring platform. The repositioning belt supports the bedridden user and rotates the bedridden user to prevent bedsores. The translation mechanism facilitates the movement of the repositioning belt without requiring a caretaker to move the bedridden user. The anchoring platform facilitates the mounting of the system to the bedframe. The anchoring platform includes a platform body, a first lateral support, and a second lateral support. The platform body is an elongated structure that fits under the bedframe. The first lateral support and the second lateral support help guide the movement of the repositioning belt in such a way that the movement of the repositioning belt is not obstructed by the bed or bed accessories.

### FIELD OF THE INVENTION

The present invention relates generally to medical systems and furniture attachments. More specifically, the present invention provides a system that enables the adjustment of the user's body position on a bed without the user exerting themselves nor without the aid from another person.

### BACKGROUND OF THE INVENTION

Nowadays, there are many medical conditions that limit the movement of the patient to various degrees. Depending on the condition and its severity, the patient may become bedridden. Bedridden patients often require extra care aside from the usual medical care due to their limited movement. For example, the bedridden patient may require assistance to perform basic needs such as defecating or urinating, getting up to eat, etc. Further, due to physical inactivity and the prolonged time of the patient laying on the bed, the patient may suffer from additional physical ailments, such as bedsores. To prevent that, the patient needs to be moved to different positions on the bed periodically by a caretaker or family member. However, this process can be a hassle and time consuming if not performed by a professional. If the patient is sent home, family members may have a hard time repositioning the patient, specially if the patient is bigger than them. Now, there are different devices that can help people take care of bedridden patients. For example, there are medical beds designed to help reposition the patient utilizing mechanical means to do so. Further, there are support devices that help provide additional support to specific body members while laying on a bed, such as limb supports. Unfortunately, these options can be expensive or difficult to operate for many, which leaves fewer options for bedridden patients at home. Therefore, there needs to be a more efficient and cost-effective option to help reposition bedridden patients who are laying on a bed.

An objective of the present invention is to provide a body position adjustment system that helps caretakers with the repositioning of a bedridden user's body on a bed or similar piece of furniture. The present invention enables the careful repositioning of the user's body to prevent medical ailments resulting from laying on the bed, such as bedsores. Another objective of the present invention is to provide a body position adjustment system that can be retrofitted to an existing bed in a simple manner without alteration of the bedframe. The present invention can be attached to the bedframe without altering the structure of the bedframe and can operate unobstructed along with other bed accessories such as the bed comforter, blankets, etc. Another objective of the present invention is to provide a body position adjustment system that is easy to operate by the person taking care of the bedridden patient. The present invention can be operated manually or remotely by the caretaker so that the bedridden user can be properly taken care of Additional features and benefits of the present invention are further discussed in the sections below.

### SUMMARY OF THE INVENTION

The present invention is a body position adjustment system. The body position adjustment system is designed to help caretakers reposition the body of a bedridden patient to prevent further physical harm resulting from laying on the bed or similar furniture for long periods of time. The present invention preferably includes a repositioning belt, a translation mechanism, and an anchoring platform. The repositioning belt is designed to comfortably support the body of the bedridden patient who is laying on the bed. The repositioning belt also helps rotate the body of the bedridden patient to help reposition the body while the bedridden patient is laying on the bed. The translation mechanism facilitates the movement of the repositioning belt without requiring the caretaker to exert force to move the bedridden user. The translation mechanism can be provided as a manual mechanism that can be driven by the caretaker or a motorized mechanism that can be directly or remotely engaged by the caretaker. The anchoring platform helps secure the repositioning belt and the translation mechanism to the bedframe so that each component is securely connected to the bedframe. The anchoring platform also enables the operation of the repositioning belt and the translation mechanism without obstructing the use of other bed accessories.

### BRIEF DESCRIPTION OF THE DRAWINGS

FIG. 1 is a top front perspective view showing the present invention, wherein the present invention is shown installed on a bed.

FIG. 2 is a bottom rear perspective view showing the present invention, wherein the present invention is shown installed on a bed.

FIG. 3 is a top front perspective view showing the present invention.

FIG. 4 is a front view showing the present invention, wherein the motorized carriage of the translation mechanism is shown moving in a first linear direction to rotate the patient's body in a first angular direction.

FIG. 5 is a front view showing the present invention, wherein the motorized carriage of the translation mechanism is shown moving in a second linear direction to rotate the patient's body in a second angular direction.

FIG. 6 is a top front perspective view showing the translation mechanism and the platform body of the anchoring platform of the present invention.

FIG. 7 is a bottom rear perspective view showing the translation mechanism and the platform body of the anchoring platform of the present invention.

FIG. 8 is a top front perspective view showing a lateral support of the anchoring platform of the present invention.

FIG. 9 is a bottom rear perspective view showing a lateral support of the anchoring platform of the present invention.

FIG. 10 is a schematic view showing the electrical connections, the electronic connections, and the wireless connections of the present invention, wherein the electrical connections are shown in solid lines, the electronic connections are shown in dashed lines, and the wireless connections are shown in dotted lines.

### DETAIL DESCRIPTIONS OF THE INVENTION

All illustrations of the drawings are for the purpose of describing selected versions of the present invention and are not intended to limit the scope of the present invention.

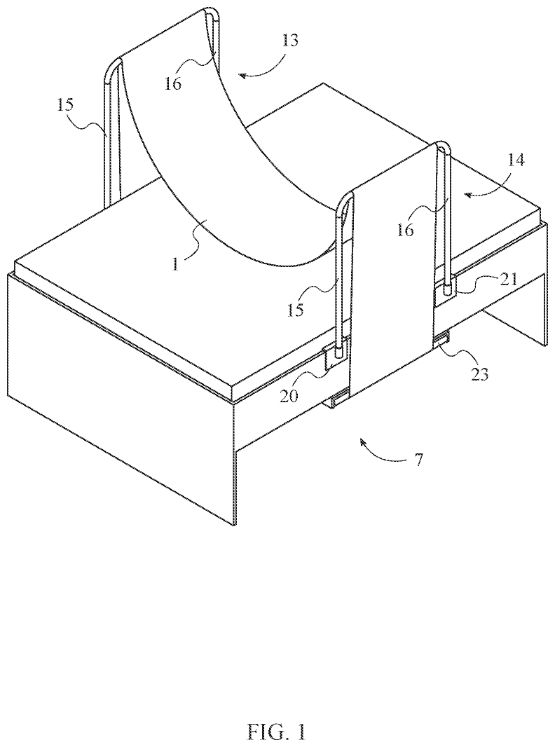

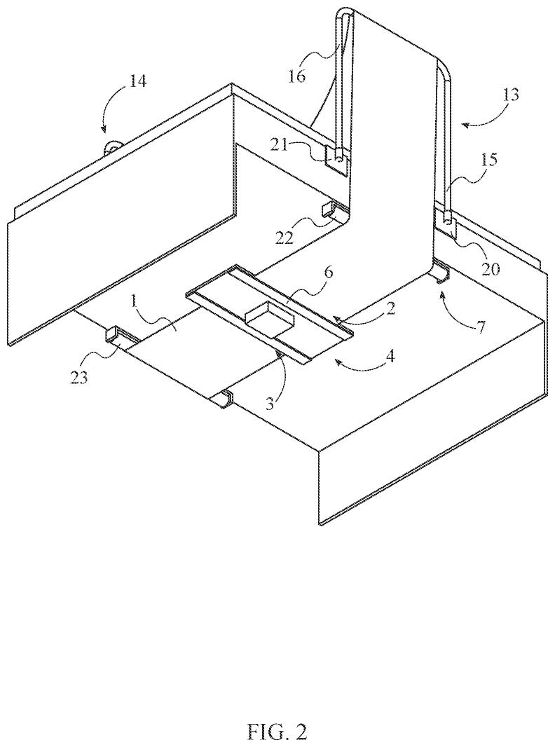

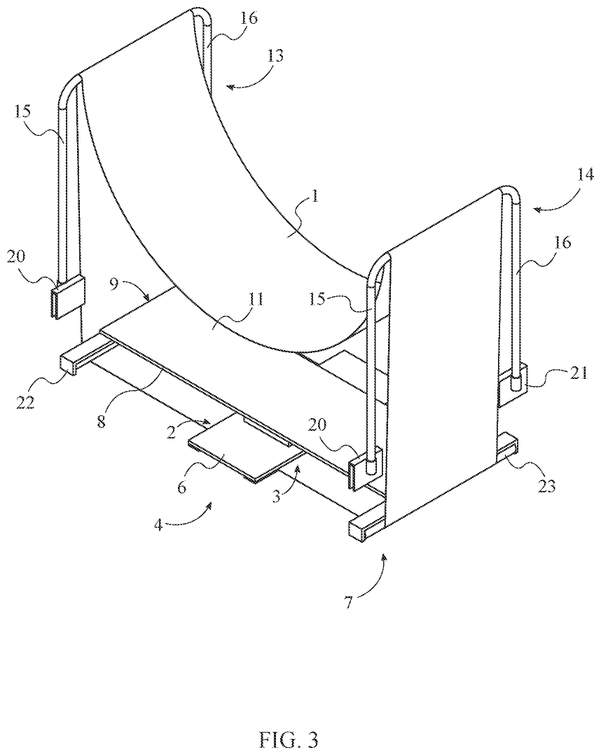

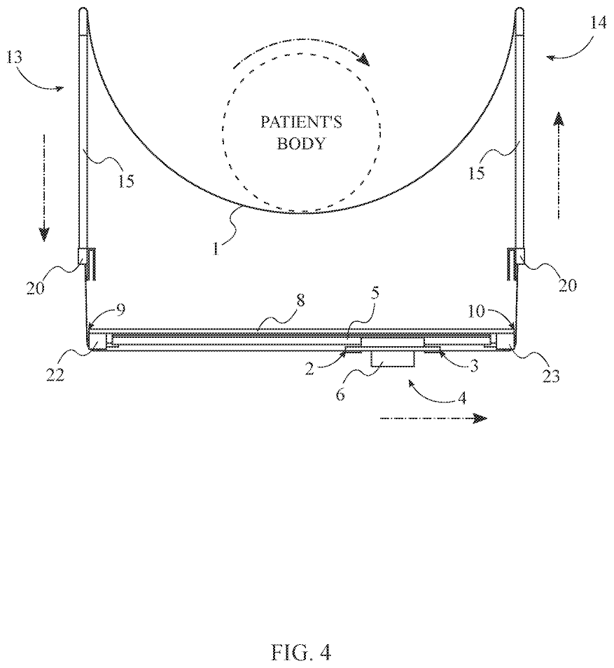

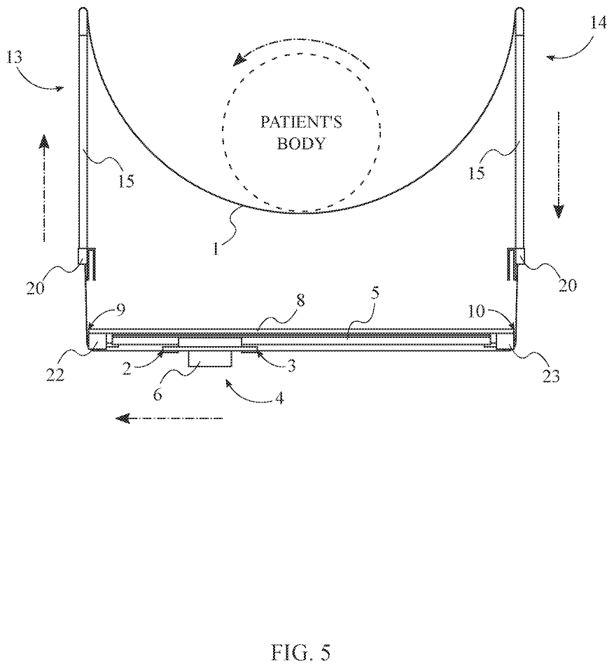

The present invention is a body position adjustment system that helps bedridden users avoid additional physical ailments resulting from laying on a bed for long periods of time. As can be seen in FIG. 1 through 5, the present invention comprises a repositioning belt 1, a translation mechanism 4, and an anchoring platform 7. The repositioning belt 1 comfortably supports the bedridden user's body and rotates the bedridden user's body as necessary to prevent bedsores. The translation mechanism 4 facilitates the movement of the repositioning belt 1 without requiring a caretaker to exert force to move the bedridden user by using the repositioning belt 1. The translation mechanism 4 can be provided as a manual mechanism or a motorized mechanism. The anchoring platform 7 facilitates the mounting of the present invention to the bedframe without obstructing the operation of the translation mechanism 4, the repositioning belt 1, or any bed accessories.

The general configuration of the aforementioned components enables caretakers to easily move bedridden users laying on a bed or similar furniture to prevent bedsores. As can be seen in FIG. 1 through 5, the present invention is designed to be easily attached to existing bedframes so that bedridden users can properly be taken care of at any location. To do so, the anchoring platform 7 comprises a platform body 8, a first lateral support 13, and a second lateral support 14. The platform body 8 is preferably an elongated structure that fits under the bedframe to support the operation of the translation mechanism 4. The first lateral support 13 and the second lateral support 14 help guide the movement of the repositioning belt 1 in such a way that the movement of the repositioning belt 1 is not obstructed by the bed or bed accessories. Due to the elongated structure of the platform body 8, the platform body 8 comprises a first platform edge 9 and a second platform edge 10 corresponding to the terminal edges of the platform body 8. The repositioning belt 1 is also a long belt structure long enough to accommodate the width of the bed and the size of the bedridden user. Accordingly, the repositioning belt 1 comprises a first belt end 2 and a second belt end 3 corresponding to the terminal ends of the repositioning belt 1.

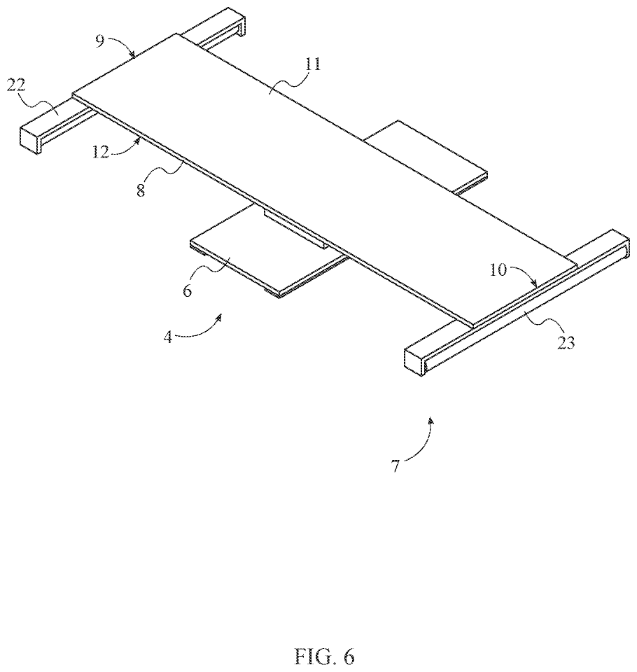

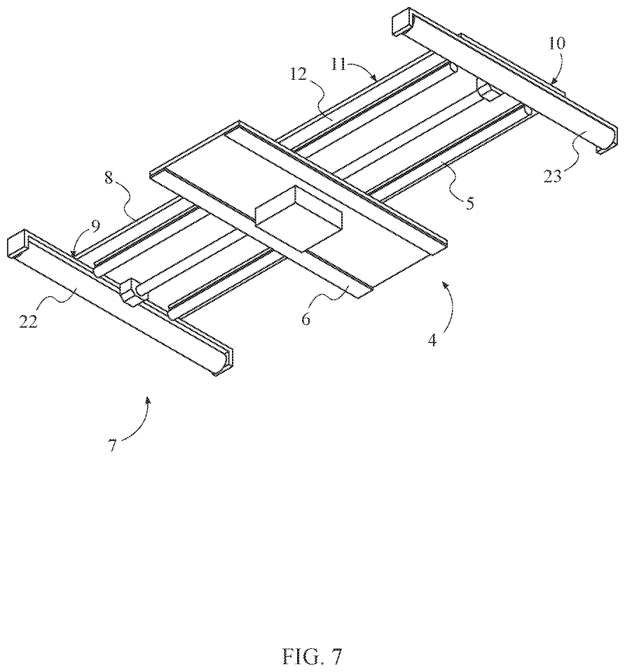

As can be seen in FIG. 1 through 7, due to the length of the platform body 8, the first platform edge 9 is positioned opposite to the second platform edge 10 across the platform body 8. The length of the platform body 8 is preferably large enough to match the width of the bedframe. To assemble the present invention, the first lateral support 13 is positioned geometrically normal to the platform body 8. In addition, the first lateral support 13 is positioned offset to the first platform edge 9. The first lateral support 13 can be mounted to a lateral edge of the bedframe or can be directly secured to the platform body 8 if necessary. Further, the second lateral support 14 is positioned parallel to the first lateral support 13 to form an overall U-shaped structure with the platform body 8.

The second lateral support 14 is also positioned offset to the second platform edge 10 so that the second lateral support 14 can be mounted to the opposite lateral edge of the bedframe. Similarly, the second lateral support 14 can be mounted to a lateral edge of the bedframe or can be directly secured to the platform body 8. This way, the first lateral support 13 and the second lateral support 14 are positioned in opposite sides of the bed to surround the bedridden user's body.

As can be seen in FIG. 1 through 7, to enable the movement of the repositioning belt 1, the translation mechanism 4 is slidably mounted along the platform body 8. This way, the translation mechanism 4 can move along the length platform body 8 to move the repositioning belt 1 in the desired direction. Further, the repositioning belt 1 is slidably mounted about the first platform edge 9, the first lateral support 13, the second lateral support 14, and the second platform edge 10. In other words, the repositioning belt 1 surrounds the anchoring platform 7 and loops around the bed while being guided by the first lateral support 13 and the second lateral support 14. This way, the bedridden user lays on the repositioning belt 1 on top of the bed so that the bedridden user's body can be rotated by the repositioning belt 1. Furthermore, to secure the repositioning belt 1 to the translation mechanism 4, the first belt end 2 is connected to the translation mechanism 4, offset to the first platform edge 9. Similarly, the second belt end 3 is connected to the translation mechanism 4, offset to the second platform edge 10. Thus, when the translation mechanism 4 moves in a first linear direction, the repositioning belt 1 rotates the bedridden user's body in a first angular direction. On the other hand, when the translation mechanism 4 moves in a second linear direction, the repositioning belt 1 rotates the bedridden user's body in a second angular direction that is opposite to the first angular direction.

As previously discussed, the platform body 8 is preferably an elongated structure that is overall flat so that the platform body 8 can be positioned under the bedframe, as can be seen in FIG. 1 through 7. Accordingly, the platform body 8 may further comprise a first platform surface 11 and a second platform surface 12 that correspond to the opposite flat surfaces of the platform body 8. The first platform surface 11 is positioned opposite to the second platform surface 12 across the platform body 8. When the platform body 8 is mounted under the bedframe, the first lateral support 13 is positioned offset to the first platform surface 11. Similarly, the second lateral support 14 is also positioned offset to the first platform surface 11. In other words, the first platform surface 11 is oriented towards the underside of the bedframe while the first lateral support 13 and the second lateral support 14 are mounted above on the lateral sides of the bedframe. Furthermore, the platform body 8 can be secured to the underside of the bedframe in multiple ways such as, but not limited to, using fasteners, clamps, etc.

The present invention is preferably designed to accommodate the structure of the bedframe without altering or damaging the bedframe. However, the movement of the repositioning belt 1 may damage the bedframe due to friction between the moving repositioning belt 1 and the bedframe. As can be seen in FIG. 1 through 7, to prevent damages to the bedframe, the present invention may further comprise a first roller 22 and a second roller 23. The first roller 22 and the second roller 23 are designed to guide the movement of the repositioning belt 1 as the repositioning belt 1 is being moved by the translation mechanism 4. Further, the first roller 22 and the second roller 23 prevent damage to the bedframe by offsetting the movement of the repositioning belt 1 from the bedframe. To secure the first roller 22 to the platform body 8, the first roller 22 is positioned adjacent to the first platform edge 9. Then, the first roller 22 is rotationally mounted onto the second platform surface 12. This way, the first roller 22 is securely mounted close to the first platform edge 9 of the platform body 8. Similarly, the second roller 23 is positioned adjacent to the second platform edge 10. Further, the second roller 23 is rotationally mounted onto the second platform surface 12. This way, the second roller 23 is securely mounted close to the second platform edge 10 of the platform body 8. Finally, the repositioning belt 1 is slidably mounted about the first roller 22, the first lateral support 13, the second lateral support 14, and the second roller 23. Thus, the repositioning belt 1 can safely be moved by the translation mechanism 4 without damaging the bedframe.

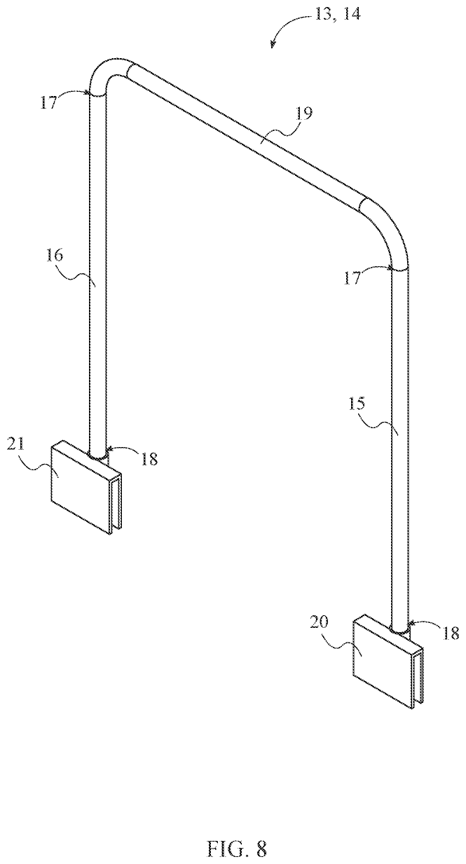

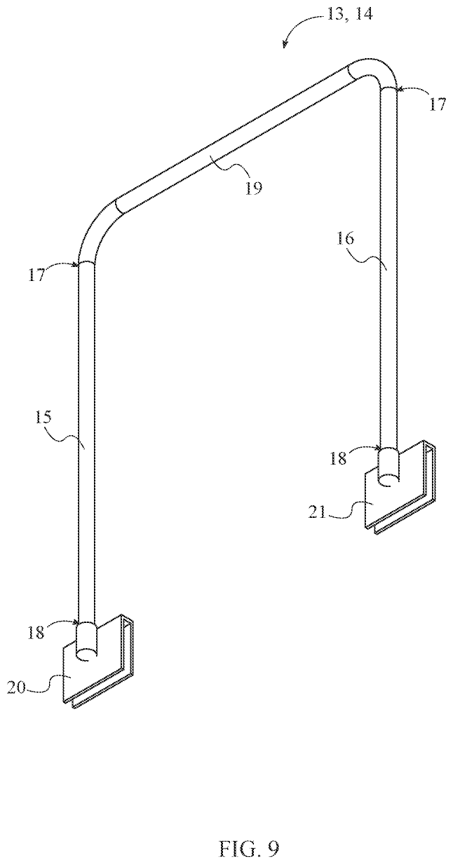

The first lateral support 13 and the second lateral support 14 are designed to not only guide the movement of the repositioning belt 1, but to also raise the repositioning belt 1 above the bedframe. As can be seen in FIGS. 1 through 5, 8, and 9, the repositioning belt 1 is elevated high enough so that the repositioning belt 1 does not drag the bedding or the bed accessories when the repositioning belt 1 is being moved by the translation mechanism 4. To do so, the first lateral support 13 and the second lateral support 14 may each comprise a first support bar 15, a second support bar 16, and a crossbar 19. The first support bar 15 and the second support bar 16 serve as the structure that raises the repositioning belt 1, while the crossbar 19 guides the repositioning belt 1. Further, the first support bar 15 and the second support bar 16 each comprises a first bar end 17 and a second bar end 18 corresponding to the terminal ends of each support bar. To assemble the corresponding lateral support, the first support bar 15 is positioned parallel to the second support bar 16 to form a straight vertical structure. Further, the first bar end 17 of the first support bar 15 is terminally connected to the crossbar 19. Similarly, the first bar end 17 of the second support bar 16 is also terminally connected to the crossbar 19, opposite to the first bar end 17 of the first support bar 15. This way, both the first support bar 15 and the second support bar 16 are securely connected to the crossbar 19. Furthermore, the second bar end 18 of the first support bar 15 is positioned offset to the platform body 8. Likewise, the second bar end 18 of the second support bar 16 is positioned offset to the platform body 8. This way, each lateral support is kept elevated from the platform body 8. In other embodiments, the crossbar 19 may also be equipped with a roller to further facilitate the movement of the repositioning belt 1 by reducing the friction between the repositioning belt 1 and the crossbar 19.

As previously discussed, the first lateral support 13 and the second lateral support 14 are preferably secured to the lateral sides of a bedframe. As can be seen in FIGS. 1 through 5, 8, and 9, to do so, the first lateral support 13 and the second lateral support 14 may each further comprise a first clamp 20 and a second clamp 21. The first clamp 20 and the second clamp 21 are designed to enable the quick and secure fastening of the corresponding lateral support to the bedframe. To do so, the first clamp 20 of the first lateral support 13 is connected to the second bar end 18 of the first support bar 15 of the first lateral support 13. On the other hand, the second clamp 21 of the first lateral support 13 is connected to the second bar end 18 of the second support bar 16 of the first lateral support 14. This enables the first lateral support 13 to be mounted onto and secured to the bedframe using the corresponding first clamp 20 and second clamp 21. Likewise, the first clamp 20 of the second lateral support 14 is connected to the second bar end 18 of the first support bar 15 of the second lateral support 14. On the other hand, the second clamp 21 of the second lateral support 14 is connected to the second bar end 18 of the second support bar 16 of the second lateral support 14. This enables the second lateral support 14 to be mounted onto and secured to the bedframe using the corresponding first clamp 20 and second clamp 21. This way, both the first lateral support 13 and the second lateral support 14 are properly secured to the bedframe to support the body weight of the bedridden user and the movement of the repositioning belt 1.

As can be seen in FIG. 1 through 7, the present invention is preferably designed to require the least effort by a caretaker to move the bedridden user periodically. Accordingly, the translation mechanism 4 is preferably a motorized system that can be engaged by the caretaker to automatically reposition the bedridden user as necessary. To do so, the present invention may further comprise a controller 24 and a power source 25. The controller 24 is a computing device that controls the operation of the translation mechanism 4, while the power source 25 provides the power necessary for the operation of the translation mechanism 4. The controller 24 can be a microcontroller 24 to lower the load on the position-adjusting track 5. The power source 25 can be a replaceable battery, a rechargeable battery, or a power system that includes a power cable that can be connected to the building utilities. Further, the translation mechanism 4 may comprise a position-adjusting track 5 and a motorized carriage 6. The positioning-adjusting track guides the movement of the motorized carriage 6 along the platform body 8. The motorized carriage 6 generates the force necessary to move the repositioning belt 1 and the bedridden user laying on the repositioning belt 1. To assembly the motorized version of the translation mechanism 4, the position-adjusting track 5 is positioned across the platform body 8 so that the motorized carriage 6 can move the whole length of the platform body 8 if necessary. Further, the position-adjusting track 5 is laterally mounted along the platform body 8 to secure the position-adjusting track 5 to the platform body 8. The motorized carriage 6 is slidably mounted along the position-adjusting track 5 so that the motorized carriage 6 is able to freely move along the position-adjusting track 5. Furthermore, the first belt end 2 is connected to the motorized carriage 6 while the second belt end 3 is connected to the motorized carriage 6, opposite to the first belt end 2. This way, the repositioning belt 1 is secured to the motorized carriage 6 on opposite ends. To maintain a compact structure, the controller 24 and the power source 25 are mounted onto the carriage. In addition, the controller 24 is electronically connected to the motorized carriage 6 to transmit electronic signals that dictate the operation of the motorized carriage 6. Further, the power source 25 is electrically connected to the controller 24 and the motorized carriage 6 to provide the current necessary for the operation of the controller 24 and the motorized carriage 6.

In some embodiments, the motorized carriage 6 is designed as light-weight structure that can hang from the position-adjusting track 5 without severely increasing the load on the platform body 8. For example, the motorized carriage 6 may include a carriage body, at least one motor, and at least one roller. As can be seen in FIG. 1 through 7, the at least one motor can be mounted onto the carriage body, adjacent to the platform body 8. The at least one roller is also rotationally mounted onto the carriage body, adjacent to the platform body 8. Further, the at least one motor is rotationally connected to the at least one roller so that the torque generated by the at least one motor is transmitted to the at least one roller. Further, the at least one motor is an electric bidirectional motor able to generate thrust in two angular directions. This way, when the at least one motor generates torque in a first angular direction, the at least one roller forces the carriage body to move in a first linear direction. For example, clockwise rotation of the at least one roller can move the carriage body towards the first platform edge 9, which moves the repositioning belt 1 also in a clockwise direction. This causes the bedridden user's body supported by the repositioning belt 1 to be rotated counterclockwise. On the other hand, when the at least one motor generates torque in a second angular direction, the at least one roller forces the carriage body to move in a second linear direction. For example, counterclockwise rotation of the at least one roller can move the carriage body towards the second platform edge 10, which moves the repositioning belt 1 also in a counterclockwise direction. This causes the bedridden user's body supported by the repositioning belt 1 to be rotated clockwise.

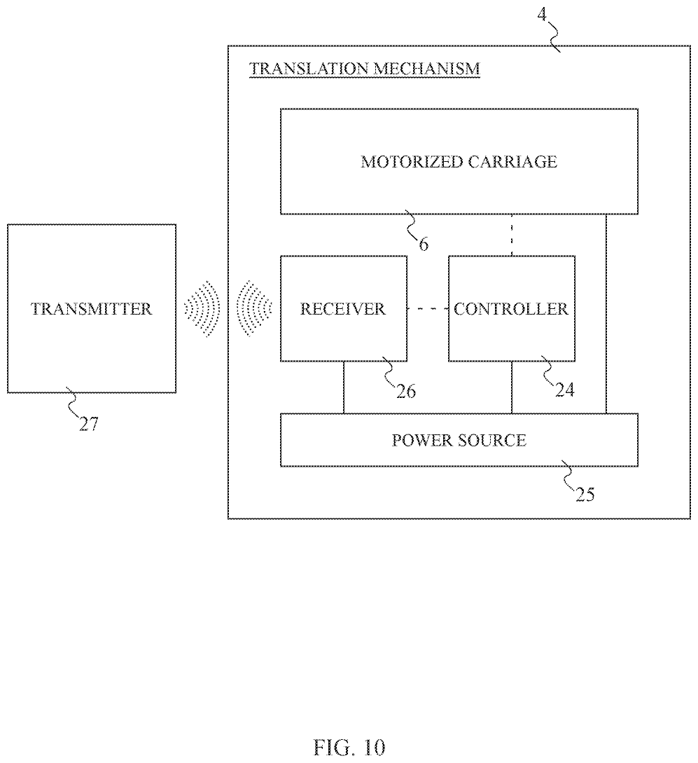

To help the caretaker control the operation of the translation mechanism 4, the present invention also provides means for direct or remote control of the motorized carriage 6. As can be seen in FIG. 10, to do so, the present invention may further comprise a receiver 26 and a transmitter 27. The receiver 26 and the transmitter 27 enable the wireless transmission of command signals to the motorized carriage 6. Accordingly, the receiver 26 is mounted onto the motorized carriage 6 while the transmitter 27 is positioned offset to the motorized carriage 6. The transmitter 27 can be provided in the form of a remote control so that the caretaker can control the operation of the motorized carriage 6 from a distance. The transmitter 27 can also be provided in the form of a user interface positioned adjacent to the present invention so that the caretaker can control the operation of the motorized carriage 6 while directly watching over the bedridden user. To enable the transmission of the operational signals to the motorized carriage 6, the receiver 26 is electronically connected to the controller 24 so that the operational signals received from the transmitter 27 are relayed to the controller 24. The receiver 26 is also electrically connected to the power source 25 to receive the power necessary for operation of the receiver 24. Further, the receiver 26 is communicably coupled to the transmitter 27 so that the operational signals are wirelessly transmitted from the transmitter 27 to the receiver 26.

In other embodiments, the translation mechanism 4 may include manual means to be moved by the caretaker of the bedridden user. The manual embodiment of the translation mechanism 4 provides a cheaper version of the present invention while still facilitating the body repositioning of the bedridden user in an efficient and comfortable way. In this embodiment, the motorized carriage 6 is replaced with a manual carriage connected to a hand crank or similar manual drive device that the caretaker can operate to move the manual carriage along the position-adjusting track 5 in the desired direction. The manual carriage can be connected to the manual drive device through different means including, but not limited to, a gear system or a pulley mechanism that transforms the torque generated by the caretaker using the manual drive device into linear motion of the manual carriage. In other embodiments, the translation mechanism 4 may include different means of moving the repositioning belt 1.

Although the invention has been explained in relation to its preferred embodiment, it is to be understood that many other possible modifications and variations can be made without departing from the spirit and scope of the invention.

What is claimed is:

1. A body position adjustment system comprising:
a repositioning belt;
a translation mechanism;
an anchoring platform;
the anchoring platform comprising a platform body, a first lateral support, and a second lateral support;
the platform body comprising a first platform edge and a second platform edge;
the repositioning belt comprising a first belt end and a second belt end;
the first platform edge being positioned opposite to the second platform edge across the platform body;
the first lateral support being positioned geometrically normal to the platform body;
the first lateral support being positioned offset to the first platform edge;
the second lateral support being positioned parallel to the first lateral support;
the second lateral support being positioned offset to the second platform edge;
the translation mechanism being slidably mounted along the platform body;
the repositioning belt being slidably mounted about the first platform edge, the first lateral support, the second lateral support, and the second platform edge;
the first belt end being connected to the translation mechanism, offset to the first platform edge; and
the second belt end being connected to the translation mechanism, offset to the second platform edge.

2. The body position adjustment system as claimed in claim 1 comprising:
the platform body further comprising a first platform surface and a second platform surface;
the first platform surface being positioned opposite to the second surface across the platform body;
the first lateral support being positioned offset to the first platform surface; and
the second lateral support being positioned offset to the first platform surface.

3. The body position adjustment system as claimed in claim 2 comprising:
a first roller;
a second roller;
the first roller being positioned adjacent to the first platform edge;
the first roller being rotationally mounted onto the second platform surface;
the second roller being positioned adjacent to the second platform edge;
the second roller being rotationally mounted onto the second platform surface; and
the repositioning belt being slidably mounted about the first roller, the first lateral support, the second lateral support, and the second roller.

4. The body position adjustment system as claimed in claim 1 comprising:
the first lateral support and the second lateral support each comprising a first support bar, a second support bar, and a crossbar;
the first support bar and the second support bar each comprising a first bar end and a second bar end;
the first support bar being positioned parallel to the second support bar;
the first bar end of the first support bar being terminally connected to the crossbar;
the first bar end of the second support bar being terminally connected to the crossbar, opposite to the first bar end of the first support bar;
the second bar end of the first support bar being positioned offset to the platform body; and
the second bar end of the second support bar being positioned offset to the platform body.

5. The body position adjustment system as claimed in claim 4 comprising:
the first lateral support and the second lateral support each further comprising a first clamp and a second clamp;
the first clamp of the first lateral support being connected to the second bar end of the first support bar of the first lateral support;
the second clamp of the first lateral support being connected to the second bar end of the second support bar of the first lateral support;
the first clamp of the second lateral support being connected to the second bar end of the first support bar of the second lateral support; and
the second clamp of the second lateral support being connected to the second bar end of the second support bar of the second lateral support.

6. The body position adjustment system as claimed in claim 1 comprising:
a controller;
a power source;
the translation mechanism comprising a position-adjusting track and a motorized carriage;
the position-adjusting track being positioned across the platform body;
the position-adjusting track being laterally mounted along the platform body;
the motorized carriage being slidably mounted along the position-adjusting track;
the first belt end being connected to the motorized carriage;
the second belt end being connected to the motorized carriage, opposite to the first belt end;
the controller and the power source being mounted onto the carriage;
the controller being electronically connected to the motorized carriage; and
the power source being electrically connected to the controller and the motorized carriage.

7. The body position adjustment system as claimed in claim 6 comprising:
a receiver;
a transmitter;
the receiver being mounted onto the motorized carriage;
the transmitter being positioned offset to the motorized carriage;
the receiver being electronically connected to the controller;
the receiver being electrically connected to the power source; and
the receiver being communicably coupled to the transmitter.

8. A body position adjustment system comprising:
a repositioning belt;
a translation mechanism;
an anchoring platform;
the anchoring platform comprising a platform body, a first lateral support, and a second lateral support;
the platform body comprising a first platform edge, a second platform edge, a first platform surface, and a second platform surface;
the repositioning belt comprising a first belt end and a second belt end;
the first platform edge being positioned opposite to the second platform edge across the platform body;
the first lateral support being positioned geometrically normal to the platform body;
the first lateral support being positioned offset to the first platform edge;
the second lateral support being positioned parallel to the first lateral support;
the second lateral support being positioned offset to the second platform edge;
the translation mechanism being slidably mounted along the platform body;
the repositioning belt being slidably mounted about the first platform edge, the first lateral support, the second lateral support, and the second platform edge;
the first belt end being connected to the translation mechanism, offset to the first platform edge;
the second belt end being connected to the translation mechanism, offset to the second platform edge;
the first platform surface being positioned opposite to the second surface across the platform body;
the first lateral support being positioned offset to the first platform surface; and
the second lateral support being positioned offset to the first platform surface.

9. The body position adjustment system as claimed in claim 8 comprising:
a first roller;
a second roller;
the first roller being positioned adjacent to the first platform edge;
the first roller being rotationally mounted onto the second platform surface;
the second roller being positioned adjacent to the second platform edge;
the second roller being rotationally mounted onto the second platform surface; and
the repositioning belt being slidably mounted about the first roller, the first lateral support, the second lateral support, and the second roller.

10. The body position adjustment system as claimed in claim 8 comprising:
the first lateral support and the second lateral support each comprising a first support bar, a second support bar, and a crossbar;
the first support bar and the second support bar each comprising a first bar end and a second bar end;
the first support bar being positioned parallel to the second support bar;
the first bar end of the first support bar being terminally connected to the crossbar;
the first bar end of the second support bar being terminally connected to the crossbar, opposite to the first bar end of the first support bar;
the second bar end of the first support bar being positioned offset to the platform body; and
the second bar end of the second support bar being positioned offset to the platform body.

11. The body position adjustment system as claimed in claim 10 comprising:
the first lateral support and the second lateral support each further comprising a first clamp and a second clamp;
the first clamp of the first lateral support being connected to the second bar end of the first support bar of the first lateral support;
the second clamp of the first lateral support being connected to the second bar end of the second support bar of the first lateral support;
the first clamp of the second lateral support being connected to the second bar end of the first support bar of the second lateral support; and
the second clamp of the second lateral support being connected to the second bar end of the second support bar of the second lateral support.

12. The body position adjustment system as claimed in claim 8 comprising:
a controller;
a power source;
the translation mechanism comprising a position-adjusting track and a motorized carriage;
the position-adjusting track being positioned across the platform body;
the position-adjusting track being laterally mounted along the platform body;
the motorized carriage being slidably mounted along the position-adjusting track;
the first belt end being connected to the motorized carriage;
the second belt end being connected to the motorized carriage, opposite to the first belt end;
the controller and the power source being mounted onto the carriage;
the controller being electronically connected to the motorized carriage; and
the power source being electrically connected to the controller and the motorized carriage.

13. The body position adjustment system as claimed in claim 12 comprising:
a receiver;
a transmitter;
the receiver being mounted onto the motorized carriage;
the transmitter being positioned offset to the motorized carriage;
the receiver being electronically connected to the controller;
the receiver being electrically connected to the power source; and
the receiver being communicably coupled to the transmitter.

14. A body position adjustment system comprising:
a repositioning belt;
a translation mechanism;
an anchoring platform;
the anchoring platform comprising a platform body, a first lateral support, and a second lateral support;
the platform body comprising a first platform edge, a second platform edge, a first platform surface, and a second platform surface;
the repositioning belt comprising a first belt end and a second belt end;
the first lateral support and the second lateral support each comprising a first support bar, a second support bar, and a crossbar;
the first support bar and the second support bar each comprising a first bar end and a second bar end;
the first platform edge being positioned opposite to the second platform edge across the platform body;
the first lateral support being positioned geometrically normal to the platform body;
the first lateral support being positioned offset to the first platform edge;
the second lateral support being positioned parallel to the first lateral support;
the second lateral support being positioned offset to the second platform edge;
the translation mechanism being slidably mounted along the platform body;
the repositioning belt being slidably mounted about the first platform edge, the first lateral support, the second lateral support, and the second platform edge;
the first belt end being connected to the translation mechanism, offset to the first platform edge;
the second belt end being connected to the translation mechanism, offset to the second platform edge;
the first platform surface being positioned opposite to the second surface across the platform body;
the first lateral support being positioned offset to the first platform surface;
the second lateral support being positioned offset to the first platform surface;
the first support bar being positioned parallel to the second support bar;
the first bar end of the first support bar being terminally connected to the crossbar;
the first bar end of the second support bar being terminally connected to the crossbar, opposite to the first bar end of the first support bar;
the second bar end of the first support bar being positioned offset to the platform body; and
the second bar end of the second support bar being positioned offset to the platform body.

15. The body position adjustment system as claimed in claim 14 comprising:
a first roller;
a second roller;
the first roller being positioned adjacent to the first platform edge;
the first roller being rotationally mounted onto the second platform surface;
the second roller being positioned adjacent to the second platform edge;
the second roller being rotationally mounted onto the second platform surface; and
the repositioning belt being slidably mounted about the first roller, the first lateral support, the second lateral support, and the second roller.

16. The body position adjustment system as claimed in claim 14 comprising:
the first lateral support and the second lateral support each further comprising a first clamp and a second clamp;
the first clamp of the first lateral support being connected to the second bar end of the first support bar of the first lateral support;
the second clamp of the first lateral support being connected to the second bar end of the second support bar of the first lateral support;
the first clamp of the second lateral support being connected to the second bar end of the first support bar of the second lateral support; and
the second clamp of the second lateral support being connected to the second bar end of the second support bar of the second lateral support.

17. The body position adjustment system as claimed in claim 14 comprising:
a controller;
a power source;
the translation mechanism comprising a position-adjusting track and a motorized carriage;
the position-adjusting track being positioned across the platform body;
the position-adjusting track being laterally mounted along the platform body;
the motorized carriage being slidably mounted along the position-adjusting track;
the first belt end being connected to the motorized carriage;
the second belt end being connected to the motorized carriage, opposite to the first belt end;
the controller and the power source being mounted onto the carriage;
the controller being electronically connected to the motorized carriage; and
the power source being electrically connected to the controller and the motorized carriage.

18. The body position adjustment system as claimed in claim 17 comprising:
a receiver;
a transmitter;
the receiver being mounted onto the motorized carriage;
the transmitter being positioned offset to the motorized carriage;
the receiver being electronically connected to the controller;
the receiver being electrically connected to the power source; and
the receiver being communicably coupled to the transmitter.
